(19) United States
(12) Patent Application Publication
(10) Pub. No.: US 2026/0266331 A1
(43) Pub. Date: Sep. 10, 2026

(54) DUST COVER FOR BALL JOINT

(71) Applicant: ILJIN Co., LTD., Gyeongju-si Gyeongsangbuk-do (KR)

(72) Inventors: Cheol Soon YIM, Yeoju-si Gyeonggi-do (KR); Young Uk CHOI, Daegu (KR)

(73) Assignee: ILJIN Co., LTD., Gyeongju-si Gyeongsangbuk-do (KR)

(21) Appl. No.: 19/559,021

(22) Filed: Mar. 6, 2026

(30) Foreign Application Priority Data
Mar. 7, 2025 (KR) 10-2025-0029831

(51) Int. Cl. F16C 11/06

(52) U.S. Cl. CPC F16C 11/0666

(57) ABSTRACT

A dust cover for a ball joint including a ball stud provided with a ball member and a rod member extending to one side of the ball member, includes a rod-member coupling portion 510 coupled to a dust-cover mounting portion formed on the rod member of the ball stud. The rod-member coupling portion includes a first sealing portion in contact with one side surface of the dust-cover mounting portion. The first sealing portion includes a first inclined surface having a first inclination angle α with respect to an imaginary plane A perpendicular to a central axis of the ball stud, and a second inclined surface having a second inclination angle β with respect to the imaginary plane A perpendicular to the central axis of the ball stud. The second inclination angle β is greater than the first inclination angle α.

### CROSS-REFERENCE TO RELATED APPLICATION

This application claims priority to Korean Patent Application No. 10-2025-0029831 filed on Mar. 7, 2025, the entire contents of which are herein incorporated by reference.

### TECHNICAL FIELD

The present disclosure relates to a dust cover used in a ball joint mounted on a stabilizer link or the like of a vehicle, and more particularly, to a dust cover for a ball joint with an improved sealing function.

### BACKGROUND

A ball joint in which a spherical ball member is inserted into and supported by a housing is a device that assists a relative movement between components, and is widely used in a suspension device, a steering device or the like of a vehicle.

The ball joint is configured such that the ball member provided at one end of a ball stud is inserted into and supported in an internal reception space of the housing. A dust cover is mounted around a site where the ball stud is coupled to the housing in order to prevent foreign matters such as moisture or dust from being introduced into the ball joint.

However, in the ball joint mounted on the stabilizer link of the vehicle, the ball stud is rotated with a behavior of the vehicle. At this time, a slip may occur at a site where the ball stud comes into contact with dust cover, which may reduce a sealing function. As a result, moisture or the like may be introduced into the ball joint, which may reduce durability of the ball joint and cause noise or vibration.

In particular, vehicles used in extremely cold regions require a high-pressure washing. During such a washing, high-pressure water may be easily introduced into the ball joint. This may reduce the performance of the ball joint or increase damage on the ball joint. As an example, the moisture introduced into the ball joint may corrode the ball stud, which causes the ball seat to wear out and creases a play. As a result, a noise level may become severe during operation of the ball joint.

### SUMMARY

The present disclosure was made for the purpose of solving the above matters related to a dust cover for a ball joint in the related art, and the present disclosure is for the purpose of providing a dust cover for a ball joint which is capable of more reliably preventing moisture from being introduced into a ball joint.

Representative configurations of the present disclosure to achieve the aforementioned purpose are as follows.

According to an example embodiment of the present disclosure, a dust cover for a ball joint including a ball stud 200 provided with a ball member 210 and a rod member 220 extending to one side of the ball member 210, may include a rod-member coupling portion 510 coupled to a dust-cover mounting portion 230 formed on the rod member 220 of the ball stud 200. The rod-member coupling portion 510 may include a first sealing portion 512 in contact with one side surface 230b of the dust-cover mounting portion 230. The first sealing portion 512 may include a first inclined surface 515 having a first inclination angle α with respect to an imaginary plane A perpendicular to a central axis of the ball stud 200, and a second inclined surface 514 having a second inclination angle β with respect to the imaginary plane A perpendicular to the central axis of the ball stud 200. The second inclination angle β may be greater than the first inclination angle α so that the rod-member coupling portion 510 comes into contact with an end of the one side surface 230b of the dust-cover mounting portion 230.

In an aspect, a dust lip 513 may be formed on the first inclined surface 515. A third inclined surface 511 may be formed between the dust lip 513 and the second inclined surface 514 to be axially positioned closer to the ball member 210 than the first inclined surface 515.

In an aspect, the first inclination angle α may be in a range of 5 degrees to 15 degrees. The second inclination angle β may be in a range of 30 degrees to 45 degrees.

In an aspect, a length L1 of a gap between the first inclined surface 515 and the third inclined surface 511 may be in a range of 0.1 millimeter (mm) to 0.3 mm.

In an aspect, the rod-member coupling portion 510 may include a second sealing portion 516 in contact with a bottom surface 230a of the dust-cover mounting portion 230. The second sealing portion 516 may have a plurality of recesses and a plurality of sealing lips formed thereon.

In an aspect, the rod-member coupling portion 510 may have a clip-ring mounting surface 519 formed on an outer peripheral surface thereof, and a clip ring 600 is mounted on the clip-ring mounting surface 519. The axial central line C1 of the clip-ring mounting surface 519 may be positioned to be axially farther from the ball member 210 than an axial central line C2 of the second sealing portion 516.

In an aspect, the second sealing portion 516 may have a first recess 517a, a second recess 517b, and a third recess 517c which are sequentially formed downward from above. The second sealing portion 516 may have a first sealing lip 518a, a second sealing lip 518b, a third sealing lip 518c, and a fourth sealing lip 518d which are sequentially formed downward from above.

In an aspect, a portion of the first sealing lip 518a may be formed by a tapered surface 521 having an inclination angle greater than the first inclination angle of the first inclined surface 515.

In an aspect, each of ends of the first sealing lip 518a and the fourth sealing lip 518d may have a flat surface in contact with the bottom surface 230a of the dust-cover mounting portion 230. Each of ends of the second sealing lip 518b and the third sealing lip 518c may have a convex surface in contact with the bottom surface 230a of the dust-cover mounting portion 230.

In an aspect, the second recess 517b may be formed at a depth greater than depths of the first recess 517a and the third recess 517c. A difference L3 between the depth of the second recess 517b and the depths of the first recess 517a and the third recess 517c may be in a range of 0.1 mm to 0.5 mm. An axial gap L2 between the axial central line C1 of the clip-ring mounting surface 519 and the axial central line C2 of the second sealing portion 516 may be in a range of 0.2 mm to 1 mm.

According to another example embodiment, the ball joint may include the dust cover of any one of the aforementioned configurations.

According to an example embodiment of the present disclosure, a first sealing portion is formed to have a two-stage inclination structure composed of a first inclined surface and a second inclined surface, which makes it possible to prevent foreign matters such as moisture from being introduced into a ball joint at an initial stage.

Further, according to an example embodiment of the present disclosure, a third inclined surface is positioned between a dust lip and the second inclined surface to be axially closer to the ball member than the first inclined surface. Thus, even if the dust lip is deformed, a space which can accommodate the deformed dust lip is ensured, which makes it possible to prevent the dust lip from being excessively deformed, and therefore, suppress the dust lip from wearing out excessively.

Further, according to an example embodiment of the present disclosure, a contact shape of a second sealing portion is improved, so that a ball stud and a sealing lip are evenly brought into contact with each other. This enhances a sealing effect. This sealing effect is more beneficial when the ball stud vibrates.

### BRIEF DESCRIPTION OF THE DRAWINGS

FIG. 1 exemplarily illustrates a structure of a ball joint according to an example embodiment of the present disclosure.

FIG. 2 exemplarily illustrates an example of a cross-sectional structure of the ball joint according to an example embodiment of the present disclosure.

FIG. 3 illustrates a dust cover before being mounted on a ball stud and a housing.

FIG. 4 is an enlarged view of a rod-member coupling portion of the dust cover.

FIG. 5 illustrates a state in which the dust cover of FIG. 4 is mounted on a dust-cover mounting portion.

FIG. 6 illustrates a dust cover before being mounted on a ball stud in a comparative example.

FIG. 7 illustrates a state in which the dust cover according to the comparative example illustrated in FIG. 6 is mounted on a dust-cover mounting portion.

### DETAILED DESCRIPTION

Hereinafter, preferred example embodiments of the present disclosure will be described in detail with reference to the accompanying drawings at such an extent that they may be readily practiced by those ordinary skilled in the art.

In order to clearly describe the present disclosure, detailed descriptions of parts irrelevant to the present disclosure will be omitted, and the same reference numerals will be given to the same constituent elements throughout the specification. Further, a shape and size of each constituent element illustrated in the drawings are arbitrarily illustrated for the sake of convenience in description, and hence the present disclosure is not necessarily limited to the shape and size illustrated. That is, it is to be understood that specific shapes, structures, and characteristics described herein may be modified from an example embodiment to another embodiment without departing from the spirit and scope of the present disclosure. Positions or arrangements of individual constituent elements may also be modified without departing from the spirit and scope of the present disclosure. Therefore, the detailed description described below is not to be taken in a limiting sense, and the scope of the present disclosure is to be taken as covering the scope claimed by the appended claims and their equivalents.

The present disclosure relates to a dust cover for a ball joint. Hereinafter, a ball joint will be described to facilitate understanding, and subsequently, a dust cover of the present disclosure used for the ball joint will be described.

### Ball Joint

The ball joint is used in a stabilizer link or the like that connects a suspension arm of a suspension device of a vehicle and a stabilizer, and performs a function of enabling various relative movements between parts connected to each other.

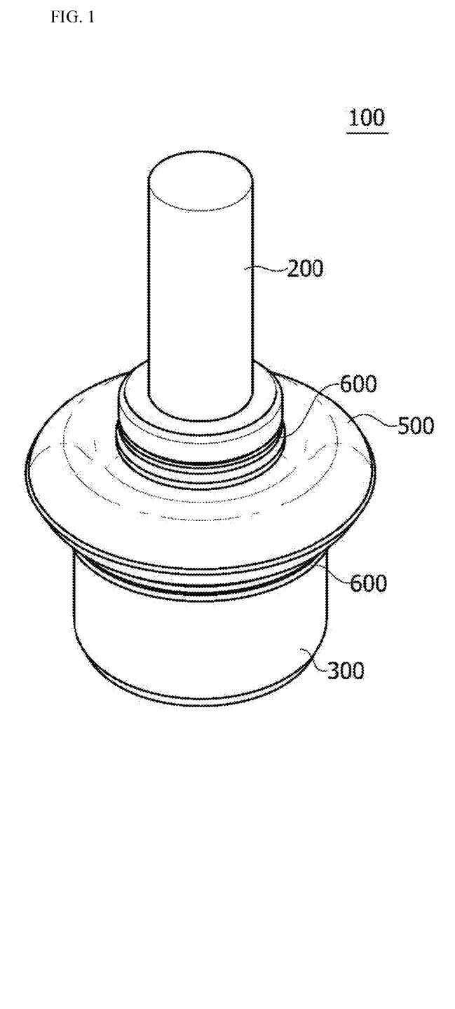

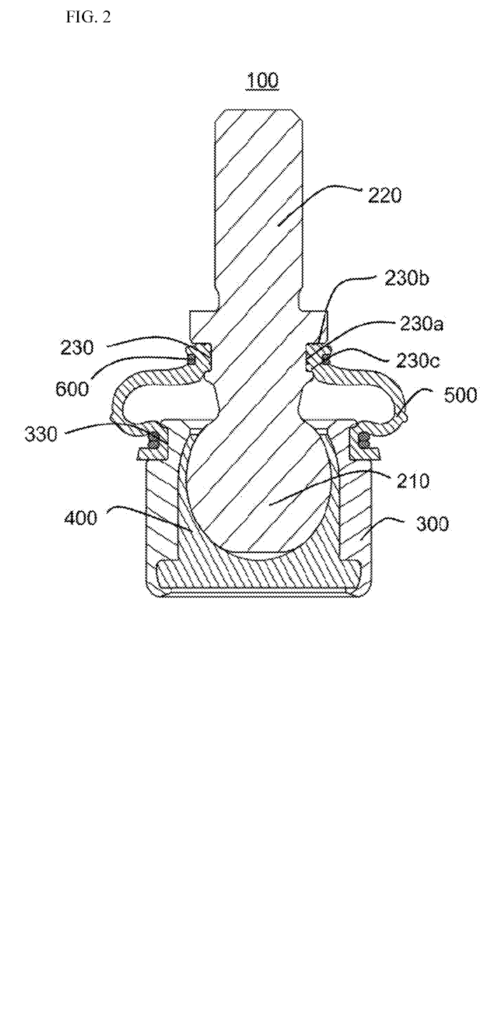

FIG. 1 exemplarily illustrates a structure of a ball joint according to an example embodiment of the present disclosure. FIG. 2 exemplarily illustrates a cross-sectional structure of the ball joint according to an example embodiment of the present disclosure. Referring to FIGS. 1 and 2, specifically, a ball joint 100 according to an example embodiment of the present disclosure may be configured to include a ball stud 200 with a spherical ball member 210, a housing 300 in which the ball stud 200 is mounted, and a ball seat 400 provided between the ball stud 200 (specifically, the ball member 210 of the ball stud 200) and the housing 300.

The ball stud 200 is a member which is supported by the housing 300 and allows a part connected to the ball stud 200 to rotate in various directions. The ball stud 200 may include the ball member 210 formed in a substantially spherical shape and a rod member 220 extending in a substantially rod shape from one side of the ball member 210.

The rod member 220 may include a dust-cover mounting portion 230 on an outer peripheral surface thereof. A dust cover 500 (to be described later) is mounted on the dust-cover mounting portion 230. A component, which operates while being connected to the ball joint, may be mounted on one end portion of the rod member 220 (an opposite end portion of the ball member 210).

According to an example embodiment of the present disclosure, the dust-cover mounting portion 230 formed on the rod member 220 may be formed to have a recess structure formed on the outer peripheral surface of the rod member 220, for example, a recess structure composed of a bottom surface 230a and two side surfaces 230b and 230c. However, the recess structure forming the dust-cover mounting portion 230 is not limited to the shape illustrated in the figures but may be formed in various shapes.

The housing 300 is a member which accommodates the ball member 210 of the ball stud 200 and supports the ball stud 200. The housing 300 may be configured to define an accommodation space in a central portion thereof. The ball member 210 of the ball stud 200 is accommodated in the accommodation space. An opening may be formed on one side of the housing 300 so that the rod member 220 of the ball stud 200 is exposed through the opening and extends outward of the housing 300.

A dust-cover mounting portion 330 on which one end of a dust cover 500 (to be described later) is mounted, may be provided on one side of the housing 300. For example, the dust-cover mounting portion 330 formed on the housing 300 may be formed to have a recess structure on an outer peripheral surface of the housing 300. The dust cover 500 may be inserted into and mounted in a recess.

The ball seat 400 is provided between the ball member 210 and an inner peripheral surface of the housing 300 in the accommodation space of the housing 300 and performs a function of supporting the ball member 210. The ball seat 400 may be formed of a synthetic resin material or the like having good wear resistance and high elasticity. A raceway is formed on the inner peripheral surface of the ball seat 400 such that a surface of the ball member 210 comes into contact with the raceway. The ball seat 400 may be formed as a single member as illustrated in the figure, or may be formed to have a structure in which a bearing seat surrounding the ball member 210 and a molding member surrounding the bearing seat are combined with each other.

### Dust Cover

According to an example embodiment of the present disclosure, the dust cover 500 performs a function of surrounding a coupling portion of the ball stud 200 and the housing 300 to prevent moisture or foreign matters from being introduced into the ball joint. For example, the dust cover 500 may be formed of a soft rubber, a synthetic resin or the like. The dust cover 500 may be configured such that one end thereof is coupled to the ball stud 200 and the other end is coupled to the housing 300, thereby sealing an area around the coupling portion of the ball stud 200 and the housing 300.

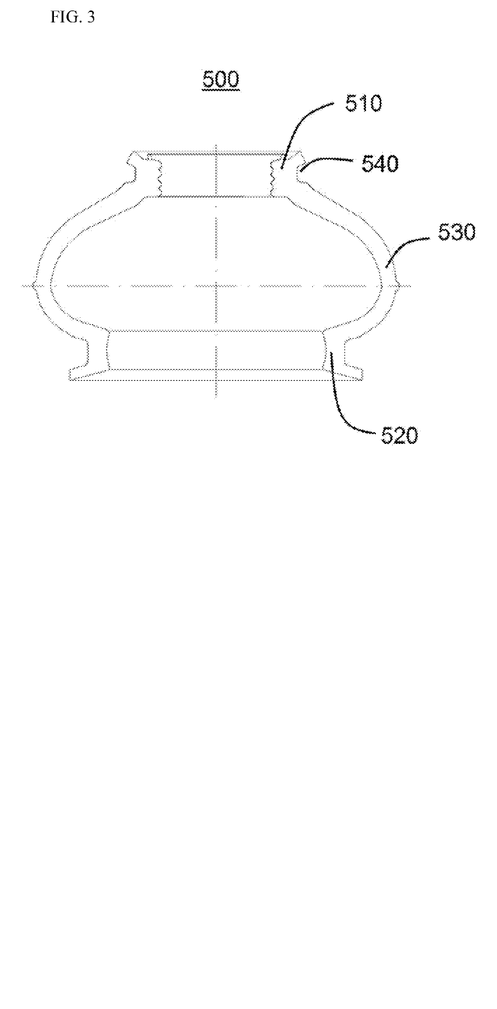

As illustrated in FIG. 3, according to an example embodiment of the present disclosure, the dust cover 500 may be configured to include a rod-member coupling portion 510 formed at one end portion of the dust cover 500 to be fastened to the rod member 220, a housing coupling portion 520 formed at the other end of the dust cover 500 to be fastened to the housing 300, and a cover body portion 530 provided between the rod-member coupling portion 510 and the housing coupling portion 520.

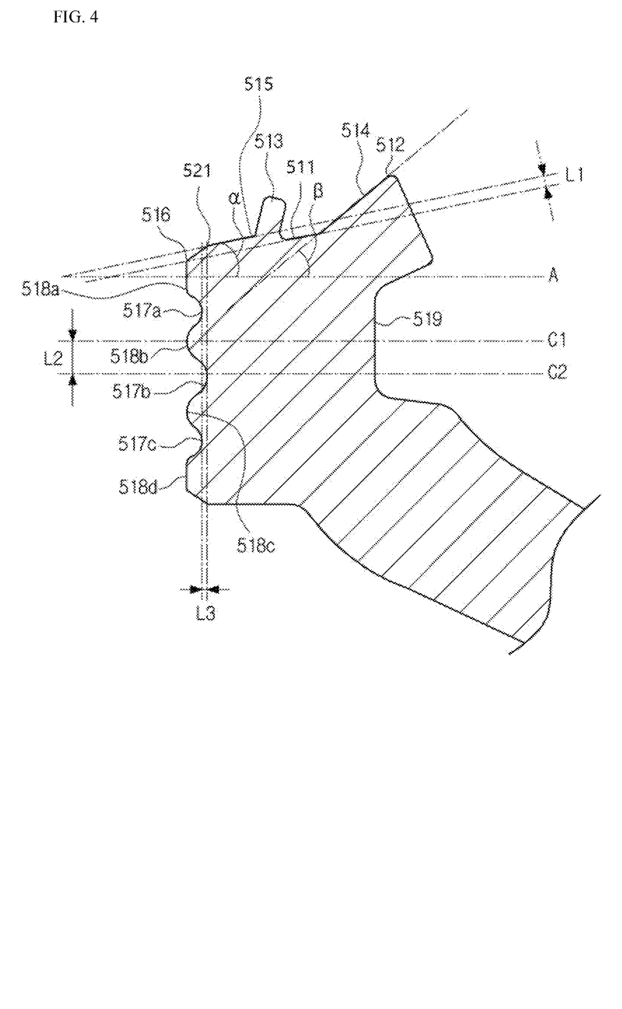

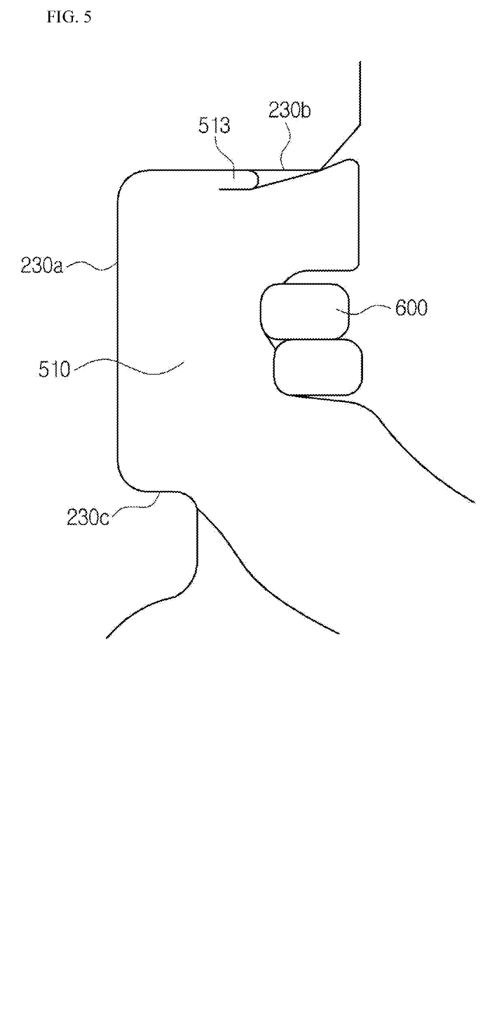

FIG. 3 illustrates the dust cover before being mounted on the ball stud and the housing. FIG. 4 is an enlarged view of the rod-member coupling portion of the dust cover. FIG. 5 illustrates a state in which the dust cover of FIG. 4 is mounted on the dust-cover mounting portion.

Referring to FIGS. 3 to 5, according to an example embodiment of the present disclosure, the rod-member coupling portion 510 of the dust cover 500 may be configured to be inserted into and coupled to the dust-cover mounting portion 230 formed on the rod member 220 of the ball stud 200. The rod-member coupling portion 510 has a fastening groove 540 formed in an outer peripheral surface thereof and may be configured such that a fastening member such as a clip ring 600 is inserted into the fastening groove 540 to stably fasten the dust cover 500 to the rod member 220 of the ball stud 200.

According to an example embodiment of the present disclosure, the rod-member coupling portion 510 of the dust cover 500 may include a first sealing portion 512 in contact with and coupled to one side surface (in the case of the example embodiment illustrated in the figure, the side surface 230b located on the opposite side of the ball member 210) of the dust-cover mounting portion 230 of a recess shape formed in the rod member 220, and a second sealing portion 516 in contact with and coupled to the bottom surface 230a of the dust-cover mounting portion 230 of a recess shape.

The dust cover 500 of the present disclosure has the first sealing portion 512 and the second sealing portion 516, which are improved to prevent moisture from being introduced into the ball joint. Details thereof will be described below.

### First Sealing Portion

Referring to FIGS. 3 to 5, according to an example embodiment of the present disclosure, in a state before the dust cover 500 is mounted to the ball stud and the housing, the first sealing portion 512 may have a two-stage inclination structure composed of a first inclined surface 515 having a first inclination angle α with respect to an imaginary plane A perpendicular to an axial direction of the dust cover 500, and a second inclined surface 514 having a second inclination angle β with respect to the imaginary plane A perpendicular to the axial direction of the dust cover 500.

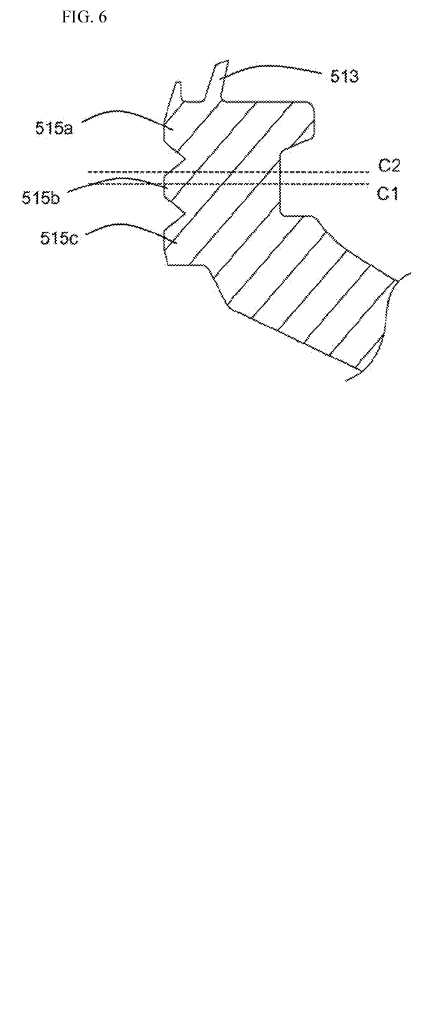

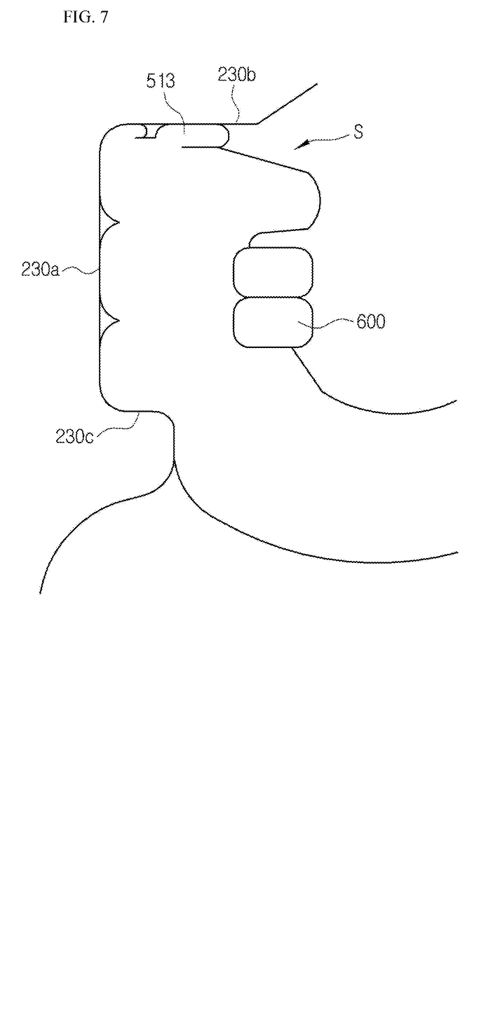

FIG. 6 illustrates the dust cover before being mounted on the ball stud in a comparative example. FIG. 7 illustrates a state in which the dust cover of the comparative example illustrated in FIG. 6 is mounted on the dust-cover mounting portion.

As can be seen in FIGS. 6 and 7, since the dust cover of the comparative example is pulled down, a space S into which foreign matters such as moisture is introduced is formed. As a result, the foreign matters may be easily introduced at an initial stage, and the dust lip may easily wear out due to the introduced foreign matters. In contrast, in the dust cover according to an example embodiment of the present disclosure, the first inclined surface 515 having the first inclination angle α is formed. With this configuration, when the rod-member coupling portion 510 of the dust cover 500 is coupled to the dust-cover mounting portion 230, the first inclined surface 515 may be more closely coupled to a side surface of the recess forming the dust-cover mounting portion 230 (in the case of the example embodiment illustrated in the figure, the side surface 230b of the recess). This further improves a sealing property of the ball joint. In addition, since the second inclined surface 514 having the second inclination angle β greater than the first inclination angle α is formed, the dust cover 500 is not pulled down unlike the comparative example. The rod-member coupling portion 510 comes into contact with an end of the side surface 230b of the dust-cover mounting portion 230 so that the foreign matters are prevented from being introduced into the ball joint at the initial stage. For this purpose, preferably, the first inclination angle α may be in a range of 5 degrees to 15 degrees, and the second inclination angle β may be in a range of 30 degrees to 45 degrees.

Further, according to an example embodiment of the present disclosure, a dust lip 513 may be formed on the first inclined surface 515. The dust lip 513 may be formed at a position radially spaced apart from the second sealing portion 516. Preferably, the dust lip 513 may be formed to have an inclination angle in a range of 60 degrees to 90 degrees with respect to the imaginary plane A perpendicular to the axial direction of the dust cover 500.

According to an example embodiment of the present disclosure, the third inclined surface 511 may be arranged in the radially outward direction with reference to the dust lip 513. That is, the first sealing portion 512 may have the third inclined surface 511 between the dust lip 513 and the second inclined surface 514.

According to an example embodiment of the present disclosure, the third inclined surface 511 is positioned axially closer to the ball member 210 than the first inclined surface 515.

Preferably, a length L1 of a gap between the first inclined surface 515 of the dust lip 513 in a radially inward direction and the third inclined surface 511 of the dust lip 513 in the radially outward direction may be in a range of 0.1 millimeter (mm) to 0.3 mm.

In the dust cover of the comparative example, a surface of the dust lip in the radially inward direction and a surface of the dust lip in the radially outward direction are positioned on the same plane. Thus, when the dust cover is mounted on the ball stud, an amount of pressure increases due to bending of the dust lip 513, which causes excessive deformation of the dust cover. This makes the dust cover wear out easily. In contrast, according to an example embodiment of the present disclosure, since the third inclined surface 511 is formed to be lower than the first inclined surface 515, even if the dust lip 513 is deformed, a space which can accommodate such a deformation is provided, thereby preventing excessive deformation of the dust lip 513 or preventing the dust lip 513 from wearing out. In FIG. 4, the inclination angle of the third inclined surface 511 is illustrated as being identical to the inclination angle of the first inclined surface 515, but the inclination angle of the third inclined surface 511 is not limited to this example. For example, in a range where the third inclined surface 511 accommodates the dust lip 513, the inclination angle of the third inclined surface 511 may be formed at an angle that is the same as or similar to the inclination angle of the first inclined surface 515.

### Second Sealing Portion

According to an example embodiment of the present disclosure, the second sealing portion 516 provided in the rod-member coupling portion 510 of the dust cover 500 may have a plurality of recesses 517a, 517b, and 517c. Protrusions formed as the recesses 517a, 517b, and 517c are formed function as sealing lips 518a, 518b, 518c, and 518d. The second sealing portion 516 may suppress the foreign matters such as moisture from being introduced between the ball stud 200 and the dust cover 500.

According to an example embodiment of the present disclosure, an axial central line C1 of the clip-ring mounting surface 519 is arranged axially farther from the ball member 210 than an axial central line C2 of the second sealing portion 516. Preferably, an axial gap L2 between the axial central line C1 of the clip-ring mounting surface 519 and the axial central line C2 of the second sealing portion 516 may be in a range of 0.2 mm to 1 mm.

In addition, according to an example embodiment of the present disclosure, the second sealing portion 516 may have the first recess 517a, the second recess 517b, and the third recess 517c, which are formed sequentially downward from above. Thus, the second sealing portion 516 may be configured to have the first sealing lip 518a, the second sealing lip 518b, the third sealing lip 518c, and the fourth sealing lip 518d, which are formed sequentially downward from above by the first recess 517a, the second recess 517b, and the third recess 517c. A depth of the second recess 517b is greater than depths of the first recess 517a and the third recess 517c. Preferably, a difference L3 between the depth of the second recess 517b and the depths of the first recess 517a and the third recess 517c may be in a range of 0.1 mm to 0.5 mm.

In the dust cover of the comparative example, the axial central line C1 of the clip-ring mounting surface is positioned closer to the ball member 210 than the axial central line C2 of the second sealing portion 516. In addition, two recesses are provided and depths of the two recesses are the same.

In the comparative example, since the axial central line C1 of the clip-ring mounting surface is positioned axially closer to the ball member 210 than the axial central line C2 of the second sealing portion 516, a clipping force of the clip ring 600 mainly acts on the second sealing lip 515b and the third sealing lip 515c, and a contact force between the first sealing lip 515a and the ball stud 200 becomes relatively small. In contrast, in the dust cover according to an example embodiment of the present disclosure, the axial central line C1 of the clip-ring mounting surface 519 is arranged axially farther from the ball member 210 than the axial central line C2 of the second sealing portion 516, and four sealing lips 518a, 518b, 518c, and 518d are provided. The depth of an intermediate recess (the second recess 517b) is set to be larger than the depths of the remaining recesses 517a and 517c, thereby increasing contact areas of upper sealing lips (that is, the first sealing lip 518a and the second sealing lip 518b) (compared to those in the comparative example). Accordingly, the ball stud and the sealing lips may be evenly brought into contact with each other. This improves the sealing effect. The sealing effect is further achieved compared to the comparative example when the ball stud vibrates.

According to an example embodiment of the present disclosure, in order to improve the sealing effect of the second sealing portion 516, a portion of the first sealing lip 518a and a portion of the fourth sealing lip 518d may be formed by a tapered surface. Preferably, the portion of the first sealing lip 518d may be formed by a tapered surface 521 having an inclination angle greater than the inclination angle of the first inclined surface 515. Further, each of ends of the first sealing lip 518a and the fourth sealing lip 518d may have a flat surface in contact with the bottom surface 230a of the dust-cover mounting portion 230. Each of ends of the second sealing lip 518b and the third sealing lip 518c may have a convex surface in contact with the bottom surface 230a of the dust-cover mounting portion 230.

Although the present disclosure has been described above with specific details such as specific components and limited examples, these examples are provided only to help a more general understanding of the present disclosure, and the present disclosure is not limited thereto, and those with ordinary knowledge in the technical field to which the present disclosure pertains can make various modifications and variations based on this description.

Therefore, the spirit of the present disclosure should not be limited to the example embodiments described above, and all modifications that are equivalent or equivalent to the claims described below as well as the claims are considered to fall within the scope of the spirit of the present disclosure.

### EXPLANATION OF REFERENCE NUMERALS

100: Ball joint

200: Ball Stud

210: Ball member

220: Rod member

230: Dust-cover mounting portion

230a: Bottom surface

230b: Side surface

230c: Side surface

300: Housing

330: Dust-cover mounting portion

400: Ball Seat

500: Dust cover

510: Rod-member coupling portion

511: Third inclined surface

512: First sealing portion

513: Dust lip

514: Second inclined surface

515: First inclined surface

515a: First sealing lip

515b: Second sealing lip

515c: Third sealing lip

516: Second sealing portion

517a: First recess

517b: Second recess

517c: Third recess

518a: First sealing lip

518b: Second sealing lip

518c: Third sealing lip

518d: Fourth sealing lip

519: Clip-ring mounting surface

520: Housing coupling portion

521: Tapered surface

540: Fastening groove

600: Clip ring

What is claimed is:

1. A dust cover for a ball joint including a ball stud (200) provided with a ball member (210) and a rod member (220) extending to one side from the ball member (210), the dust cover (500) comprising:
a rod-member coupling portion (510) coupled to a dust-cover mounting portion (230) formed on the rod member (220) of the ball stud (200),
wherein the rod-member coupling portion (510) includes a first sealing portion (512) in contact with one side surface (230b) of the dust-cover mounting portion (230),
wherein the first sealing portion (512) includes a first inclined surface (515) having a first inclination angle α with respect to an imaginary plane A perpendicular to a central axis of the ball stud (200), and a second inclined surface (514) having a second inclination angle β with respect to the imaginary plane A perpendicular to the central axis of the ball stud (200), and
wherein the second inclination angle β is formed to be greater than the first inclination angle α so that the rod-member coupling portion (510) comes into contact with an end of the one side surface (230b) of the dust-cover mounting portion (230).

2. The dust cover of claim 1, wherein a dust lip (513) is formed on the first inclined surface (515), and
wherein a third inclined surface (511) is formed between the dust lip (513) and the second inclined surface (514) to be axially positioned closer to the ball member (210) than the first inclined surface (515).

3. The dust cover of claim 1, wherein the first inclination angle α is in a range of 5 degrees to 15 degrees.

4. The dust cover of claim 1, wherein the second inclination angle β is in a range of 30 degrees to 45 degrees.

5. The dust cover of claim 2, wherein a length L1 of a gap between the first inclined surface (515) and the third inclined surface (511) is in a range of 0.1 millimeter (mm) to 0.3 mm.

6. The dust cover of claim 1, wherein the rod-member coupling portion (510) includes a second sealing portion (516) in contact with a bottom surface (230a) of the dust-cover mounting portion (230), and
wherein the second sealing portion (516) has a plurality of recesses and a plurality of sealing lips formed thereon.

77 The dust cover of claim 6, wherein the rod-member coupling portion (510) has a clip-ring mounting surface (519) formed on an outer peripheral surface thereof, and a clip ring (600) is mounted on the clip-ring mounting surface (519), and
wherein an axial central line C1 of the clip-ring mounting surface (519) is positioned to be axially farther from the ball member (210) than an axial central line C2 of the second sealing portion (516).

8. The dust cover of claim 6, wherein the second sealing portion (516) has a first recess (517a), a second recess (517b), and a third recess (517c) which are sequentially formed downward from above, and
wherein the second sealing portion (516) has a first sealing lip (518a), a second sealing lip (518b), a third sealing lip (518c), and a fourth sealing lip (518d) which are sequentially formed downward from above.

9. The dust cover of claim 8, wherein a portion of the first sealing lip (518a) is formed by a tapered surface (521) having an inclination angle greater than the first inclination angle of the first inclined surface (515).

10. The dust cover of claim 8, wherein each of ends of the first sealing lip (518a) and the fourth sealing lip (518d) has a flat surface in contact with the bottom surface (230a) of the dust-cover mounting portion (230).

11. The dust cover of claim 8, wherein each of ends of the second sealing lip (518b) and the third sealing lip (518c) has a convex surface in contact with the bottom surface (230a) of the dust-cover mounting portion (230).

12. The dust cover of claim 8, wherein the second recess (517b) is formed at a depth greater than depths of the first recess (517a) and the third recess (517c).

13. The dust cover of claim 12, wherein a difference L3 between the depth of the second recess (517b) and the depths of the first recess (517a) and the third recess (517c) is in a range of 0.1 mm to 0.5 mm.

14. The dust cover of claim 7, wherein an axial gap L2 between the axial central line C1 of the clip-ring mounting surface (519) and the axial central line C2 of the second sealing portion (516) is in a range of 0.2 mm to 1 mm.

15. A ball joint comprising the dust cover of claim 1.
